(19) United States
(12) Patent Application Publication
(10) Pub. No.: US 2007/0098910 A1
(43) Pub. Date: May 3, 2007

(54) Flexible copper clad laminate, flexible printed wiring board obtained by using flexible copper clad laminate thereof, film carrier tape obtained by using flexible copper clad laminate thereof, semiconductor device obtained by using flexible copper clad laminate thereof, method of manufacturing flexible copper clad laminate and method of manufacturing film carrier tape

(75) Inventors: Makoto Yamagata, Osaki (JP); Hiroaki Kurihara, Osaki (JP); Naoya Yasui, Osaki (JP); Noriaki Iwata, Osaki (JP)

Correspondence Address: THE WEBB LAW FIRM, P.C., 700 KOPPERS BUILDING, 436 SEVENTH AVENUE, PITTSBURGH, PA, 15219, US

(73) Assignee: Mitsui Mining & Smelting Co., Ltd., Osaki (JP)

(21) Appl. No.: 11/580,683

(22) Filed: Oct. 13, 2006

(30) Foreign Application Priority Data
Oct. 14, 2005 (JP) 2005-300969

(51) Int. Cl. B05D 7/00; B05D 1/36; B32B 3/00; B32B 7/00; B32B 15/00

(52) U.S. Cl. 427/409; 428/209; 428/901

(57) ABSTRACT

An object of the invention is to provide a flexible copper clad laminate and the like in use of electro-deposited copper foil having lower profile and higher mechanical strength compared with conventional low profile electro-deposited copper foil having been supplied in the market. For attaining the object, a flexible copper clad laminate manufactured by laminating the electro-deposited copper foil to resin film, which is characterized in that a deposition surface of the electro-deposited copper foil comprises a low profile glossy surface having surface roughness (Rzjis) of not more than 1.5 μm and brightness (Gs (60°)) of not less than 400 and the deposition surface and the resin film are bonded together is adopted. And, using the flexible copper clad laminate, it may ease manufacture of a flexible printed wiring board as a film carrier tape, such as a COF tape and the like, wherein the formed wiring has a fine pitch wiring with pitch being not more than 35 μm.

### BACKGROUND OF THE INVENTION

1. Field of the Invention

The present invention relates to a flexible copper clad laminate (here in after FCCL) and a flexible printed wiring board obtained in use of the flexible copper clad laminate. In particular, it relates to a flexible printed wiring board (including a film carrier tape) for surface mounting of the electronic devices, which is so called three-layer TAB tape and COF tape, and are required to have fine wiring. And a flexible copper clad laminate which is manufactured by using electro-deposited copper foil characterized in that a deposition side has a low profile.

2. Description of the Related Art

Conventionally, electro-deposited copper foil has been widely used as a basic material for a printed wiring board. And, so-called down sizing to be small and light weight are being required to electronic and electrical equipments in which a lot of printed wiring boards are used. In prior arts, in order to realize such down sizing to electronic and electrical equipments, a signal wiring having fine pitch as much as possible was required. To perform it, they adopted thinner copper foil to shorten over-etching time in forming wirings by etching to improve etching factor in the wirings to be formed.

Besides, higher performance is required on electronic and electrical equipments to reduce size and weight at the same time. Accordingly, from the point of view of securing a device mounting area in a limited wiring board area as much as possible, better etching factor is required on the wiring. In particular, electro-deposited copper foil with lower profile is required for a three-layer tape automated bonding substrate (three-layer TAB tape) and a chip-on-film substrate (COF tape) where IC chips and the like are mounted directly than profile for a conventional printed wiring board use, and surface area on a wiring as wide as possible is required. Here, meaning of the term “low profile” is that the profile of the copper foil on the bonding side to base material is small.

With reduction in size of semiconductor devices for surface mounting, assurance for insulation reliability, free from short circuit even in a fine pitch wiring which has narrow spaces between wirings (leads) is also required for a flexible printed wiring board including the above described three-layer TAB tape and COF tape. Such a flexible printed wiring board is manufactured by etching process on such a flexible copper clad laminate that comprises an electrically conductive layer on a resin film layer represented by polyimide resin film, polyethylene terephthalate and the like. And two types on this flexible copper clad laminates are applicable.

One type is a flexible copper clad laminate comprising three-layer structure with an adhesive layer being sandwiched between a resin film layer and an electrically conductive layer, and it is a so-called “three-layer flexible copper clad laminate” which is represented by a three-layer TAB tape. In general, it is manufactured as followings. An adhesive layer is provided on the base film such as polyimide film and the like and metal foil is laminated to the adhesive layer. Accordingly, there is lower limit in thickness of the metal foil to be used, and consequently, it was difficult to form a fine pitch wiring with the certain level. In contrast, the other type is used for manufacturing COF and the like, it is that adhesive layer of the three-layer flexible copper clad laminate is eliminated, so it is called “two-layer flexible copper clad laminate”. It is manufactured by a casting method as followings. Coating a polyimide precursor varnish on the surface of metal foil in a predetermined thickness and heat it to cause an imidizing reaction. And a metalizing method is as followings. Forming a thin seed layer on the surface of polyimide resin film followed by sputtering evaporation and the like to form a copper layer and the like on the seed layer having predetermined thickness and then copper is plated by an electrolytic method. The FCCL obtained by metalizing method is suitable for forming a fine pitch wiring since thickness of the electrically conductive layer can be made thin and formed uniformly due to its manufacturing method. However, an interface between the resin layer and the metal layer is flat and smooth, so that it is easy to form the fine pitch wiring but adhesion between the resin film and the metal layer is poor. So, it gives a problem that an application is limited. In addition, in order to assure a good migration resistance, it is necessary to remove the seed layer components such as nickel and the like by etching at the time of forming a copper wiring, therefore, it increase process steps and decrease productivity.

Electro-deposited metal foil such as electro-deposited copper foil and the like is generally used for manufacturing a two-layer flexible copper clad laminate by the casting method. The electro-deposited metal foil is obtained by electrolytic deposition of metal onto the surface of a drum-shaped rotating cathode to form a foil shape, peel it continuously and wind it. The metal foil of this stage will be here in after called “drum foil”.

The peeled off surface of the drum foil contacted to the rotating cathode will show a mirror shape of the surface of the rotating cathode and is a shiny and smooth surface. Therefore it is called as “shiny side”. However, it is being managed to have a constant roughness so as to prevent from dropping off of metal foil from the rotating cathode. In contrast, the surface shape of the drum foil of the deposition side has differences in the crystal growth speed of copper to be deposited on the respective crystal sites and therefore it will show an angle relief shape. Therefore it is called as “matte side”. This matte side will be a bonding side to the insulating material at the time of manufacturing a copper clad laminate. In the above and below, the description in case of using drum foil, the term “matte side” is used.

Next, this drum foil undergoes roughening treatment and rust proofing treatment onto the matte side through the surface treatment process. Accordingly, matte side on which fine copper particles are deposited is called as “roughened surface”. Here, roughening treatment as well as rust proofing treatment will be carried out optionally in accordance with the state of use of electro-deposited copper foil as well as base material type of a flexible print wiring boards. Subsequently, in the surface treatment process, both surfaces of the copper foil undergo rust proofing treatment, then dried and wound to finish electro-deposited copper foil used for manufacturing a printed wiring board. Those skilled in the art generally call this “surface treated foil” identically, but the name used in the market is “electro-deposited copper foil”. SO, in the specifications hereof, regardless of whether roughening treatment and surface treatment is performed or not, it should be specified here that all is called “electro-deposited copper foil”.

As it is clear from above, the bonding surface (matte sides or roughened surfaces) of electro-deposited metal foil at the time of laminating electro-deposited metal foil and resin film together in case of flexible copper clad laminate have certain relief. Accordingly, when there is intention to form a wiring from the electro-deposited metal foil subjected to etching process, over-etching time in addition to etching time will be required in forming a wiring shape for removing the relief by etching. Consequently, side etching occurs on wirings to deteriorate etching factors and therefore it is considered that forming fine wiring with wiring pitch of not more than 35 μm is difficult.

Accordingly, in the field of flexible printed wiring board, it has been designated to make the matte side profile of electro-deposited copper foil to be closer to the shiny side profile to shorten over-etching time in order to solve such a problem. In view of such a point, many of products are released as electro-deposited copper foil suitable for manufacturing a flexible printed wiring board. For example, Japanese Patent Laid-Open No. 2004-35918 has disclosed electro-deposited copper foil with a thickness of 10 μm manufactured by applying electrolysis to solution of sulfuric acid with acid copper plating solution having a low profile (surface roughness) of around Rz=1.0±0.5 μm of surface profile (deposited surface roughness) on bonding side to insulating material. Japanese Patent Laid-Open No. 2004-107786 has disclosed electro-deposited copper foil of a low profile with surface roughness Rz within a range from 0.90 to 1.23 μm in use of copper electrolytic solution including amine compound and organic sulfur compound having some particular structures as additive. Moreover, Japanese Patent Laid-Open No. 9-143785 has disclosed electro-deposited copper foil wherein a surface profile Rz of deposition surface of drum foil being the same as or smaller than surface profile Rz of the shiny side of the drum foil is deposited undergoes roughening treatment.

Manufacturing electro-deposited copper foil in use of the manufacturing method disclosed in Japanese Patent Laid-Open No. 2004-35918, Japanese Patent Laid-Open No. 2004-107786 and Japanese Patent Laid-Open No. 9-143785 having been described above, a matte side with excellent low profile (occasionally called “deposition surface”) is formed. And it shows extremely excellent etching performance as low profile electro-deposited copper foil, when used to form a flexible copper clad laminate and it improve the production yield of fine pitch flexible printed wiring board including a wiring with pitch of not more than 35 μm.

However, enlargement of flat display panel (TFT panel, plasma display panel and the like) in recent years is spreading rapidly. And, screen enlargement and a concurrent shift to ground-wave digital broadcast accompany intensive enhancement in resolution due to a trend to hi-vision. Consequently, it is definite the enhancement in down sizing and high performance is also required for electronic circuits as well as printed wiring board, so finer wiring pitch is required.

In addition, a clock frequency of a personal computer representing electronic or electric equipments increases sharply so that the calculation speed gets fast dramatically. And, not only being satisfied with data processing alone as the original role of a computer in the past, but also a function to use a computer itself as an AV equipments is added. It means that being satisfied with a music playing function, DVD recording and playing function, TV receiving and recording function, videophone function and the like are added one after another.

This cause a requirement for image qualities endurable for long viewing of a display of a personal computer which is not just a data monitor but show images such as a movie film and the like and a requirement for supplying the displays with such qualities at an inexpensive price and in large quantity. Currently, liquid crystal display panel is widely used for the display and it is general to use the above described tape automated bonding substrate (three-layer TAB tape) and a chip-on-film substrate (COF tape) as a driver of the liquid crystal display panel. So, to answer the design rule for hi-vision on displays, finer wiring is required for drivers.

As described above, a requirement on electro-deposited copper foil of lower profile and higher mechanical strength compared with conventional low profile electro-deposited copper foil supplied in the market, and on both for a flexible copper clad laminate and film carrier tape and the like using the copper foil has been present.

### SUMMARY OF THE INVENTION

Therefore, the inventors intensified their researches and consequently have thought out that the electro-deposited copper foil manufactured under certain conditions is superior to conventional low profile copper foil. And when it is used for a flexible copper clad laminate, it gives dramatic improvement in the yield of a flexible printed wiring board including fine pitch wiring of not more than 35 μm wiring pitch. The present invention will be described below.

Flexible copper clad laminate related to the present invention: A flexible copper clad laminate related to the present invention is a flexible copper clad laminate manufactured by laminating electro-deposited copper foil to resin film, wherein a deposition surface of the above described electro-deposited copper foil comprises a low profile glossy surface having surface roughness (Rzjis) of not more than 1.5 μm and brightness (Gs (60°)) of not less than 400 and the deposition surface and the resin film are bonded together.

And it is preferable that one with tensile strength as received is not less than 33 kgf/m² and tensile strength after heating (180° C.′ 60 minute in the atmosphere) is not less than 30 kgf/mm² is used as the above described electro-deposited copper foil for a flexible copper clad laminate related to the present invention.

Moreover, it is preferable that one with elongation as received is not less than 5% and elongation after heating (180° C.′ 60 minute in the atmosphere) is not less than 8% is used as the above described electro-deposited copper foil for a flexible copper clad laminate related to the present invention.

And it is preferable that the above described electro-deposited copper foil obtained by electro-deposition from a copper sulfate solution containing diallyl dimethyl ammonium chloride as quaternary ammonium polymer is use for a flexible copper clad laminate related to the present invention.

In addition, the above described electro-deposited copper foil being one having undergone surface treatment of either one or two kinds or more of roughening treatment, rust proofing treatment and treatment with silane coupling agent on its deposition surface may also used for a flexible copper clad laminate related to the present invention.

And it is preferable to use the above described electro-deposited copper foil having surface roughness (Rzjis) on a deposition surface subjected to surface treatment on the electro-deposited copper foil with low profile of not more than 5 μm for a flexible copper clad laminate related to the present invention.

Flexible printed wiring board related to the present invention: it will become possible to obtain a flexible printed wiring board with high qualities by using the above described flexible copper clad laminate related to the present invention.

It is preferable for a flexible printed wiring board related to the present invention that one with tensile strength of not less than 25 kgf/mm² and elongation of not less than 10% of the electro-deposited copper foil after processing to be flexible printed wiring board is used.

In particular, by using a flexible copper clad laminate related to the present invention, it will become possible to easily manufacture flexible printed wiring boards, especially a flexible printed wiring board in a film carrier tape comprising a fine pitch wiring with wiring pitch being not more than 35 μm.

And, in the above described film carrier tape, the above described wiring is the one obtained from FCCL, laminating a electro-deposited copper foil with low profile deposition surface having surface roughness (Rzjis) of not more than 1.5 μm and brightness (Gs (60°)) of not less than 400 with resin film together, after etching process.

Semiconductor devices related to the present invention: using the above described flexible copper clad laminate, it will become possible to provide semiconductor devices with high qualities.

Method of manufacturing flexible copper clad laminate: a method of manufacturing flexible copper clad laminate related to the present invention is in particular to form a resin film layer on a low profile glossy surface with surface roughness (Rzjis) being not more than 1.5 μm and brightness (Gs (60°)) being not less than 400.

Method of manufacturing film carrier tape: a method of manufacturing a film carrier tape related to the present invention is in particular to form a resin film layer on a low profile glossy surface with surface roughness (Rzjis) and brightness (Gs (60°)) of electro-deposited copper foil respectively being not more than 1.5 μm and being not less than 400 to get a flexible copper clad laminate. The electro-deposited copper foil layer is etched to be a wiring and then film carrier tape is obtained.

A flexible copper clad laminate related to the present invention is one in which the electro-deposited copper foil having deposition surface profile lower than and being better brightness than a conventional low profile electro-deposited copper foil having been supplied in the market is laminated onto resin film. Accordingly, even if the above described surface treatment is performed onto the deposition surface, the copper foil will have a profile lower than a conventional product. The electro-deposited copper foil are suitable, in particular, for forming the fine pitch wiring such as a tape automated bonding substrate (three-layer TAB tape), a chip-on-film substrate (COF tape) and the like requiring good etching factors for a wiring.

In addition, as electro-deposited copper foil itself, since the electro-deposited copper foil has extremely small roughness on both surfaces, it has less relief points to be a place that folding stress intensified when a folding endurance test is performed. Accordingly, folding endurance will be improved in flexible copper clad laminate or flexible printed wiring board in use of the electro-deposited copper foil.

And, a flexible printed wiring board obtained in use of a flexible copper clad laminate related to the present invention has an electro-deposited copper foil layer being excellent etching properties. So, a fine pitch wiring with wiring pitch being not more than 35 μm can be made in comprise stability. Accordingly, it is preferable for use in a tape automated bonding substrate (three-layer TAB tape), a chip-on-film substrate (COF tape) and the like known as a product supplied in a tape form among flexible printed wiring boards.

### BRIEF DESCRIPTION OF THE DRAWINGS

FIG. 1 is a schematic drawing, showing a shape of a COF tape specimen for testing; and

FIG. 2 is a schematic drawing, showing a summary of a configuration of an MIT folding endurance tester.

### DETAILED DESCRIPTION OF THE PREFERRED EMBODIMENTS

Mode of flexible copper clad laminate related to the present invention: A flexible copper clad laminate related to the present invention is a flexible copper clad laminate manufactured by laminating electro-deposited copper foil to resin film, wherein a deposition surface of the above described electro-deposited copper foil comprises a low profile glossy surface having surface roughness (Rzjis) of not more than 1.5 μm and brightness (Gs (60°)) of not less than 400 and the deposition surface and the resin film are bonded together.

At first, electro-deposited copper foil used here will be described. In a strict saying, roughness on a deposition surface of electro-deposited copper foil is a concept being variable in thickness of electro-deposited copper foil. However, concepts on surface roughness and brightness of electro-deposited copper foil used for a flexible copper clad laminate related to the present invention satisfies such a condition that electro-deposited copper foil with thickness of not more than 450 μm in good productivity as electro-deposited copper foil has a low profile with surface roughness (Rzjis) on its deposition side being not more than 1.5 μm and brightness (Gs (60°)) of the deposition surface being not less than 400. And surface roughness (Rzjis) on the deposition side is preferably not more than 1.2 μm and more preferably not more than 1.0 μm. The deposition surface comprises brightness within the above described range and, as the value of its surface roughness (Rzjis) gets small, it will ease to form a fine pitch wiring.

In order to make it easier to understand electro-deposited copper foil to be used for a flexible copper clad laminate related to the present invention, process for manufacturing electro-deposited copper foil will be described again. “Electro-deposited copper foil”, which has undergone no surface treatment at all, is generally referred to as “untreated foil”, “drum foil” and the like. However, regardless of whether roughening treatment and surface treatment is performed or not, it is called “electro-deposited copper foil” simply in the present invention.

In general, the electro-deposited copper foil is manufactured by continuous production method; to flow copper sulfate based solution between a drum-shaped rotating cathode and a lead-based anode or an insoluble anode (DSA=dimension stable anode) arranged in opposite along the shape of the rotating cathode. Electro-deposited copper on the drum surface of the rotating cathode; then deposited copper is peeled off and wound continuously from the rotating cathode after it has come into a foil state. In this stage, the state is still such a state that surface treatment such as rust proofing treatment has not performed at all. After just electro-deposition, copper is in activated state and is in a state extremely easily oxidized with oxygen in the atmosphere.

The surface of the electro-deposited copper foil peeled off from the state in contact to the rotating cathode will show a mirror shape of the surface of the rotating cathode undergone mirror surface finishing subjected and is a glossy and smooth surface, so it is called as a shiny side. In contrast, the surface shape on the former deposition side is different in crystal growth speed for each crystal face of copper to be deposited and will present a convex relief shape and that will be temporally called matte side or deposition surface (“deposition surface” in the present specification will be used below). That deposition surface will become a surface bonded to an insulating layer at the time of manufacturing a copper clad laminate. And, as roughness (profile) of the deposition surface gets smaller, the electro-deposited copper foil will be called to have an excellent low profile. In the electro-deposited copper foil related to the present invention, the term, matte side, is not used since profile of the deposition surface will become smoother than a shiny side of copper foil manufactured in use of conventional electrolysis drum but simply “deposition surface” will be adopted for reference.

And the electro-deposited copper foil normally undergoes roughening treatment and rust proofing treatment onto the deposition surface in surface treatment process. Roughening treatment onto a deposition surface is applying current under a condition of so-called burnt plating in copper sulfate solution, to deposit fine copper particles on a deposition surface. Then seal plating is performed immediately in a current under a level plating condition and thereby to prevent the fine copper particles from dropping off. Accordingly, the deposition surface where fine particles are deposited will be called as a “roughening treatment surface”. Subsequently, in the surface treatment process, electro-deposited copper foil undergoes rust proofing treatment with plating and the like of zinc, a zinc alloy and chromium on its both sides, followed by drying, and it is wound and thereby electro-deposited copper foil production is completed.

In general, tracing of the manufacturing methods disclosed in the above described Japanese Patent Laid-Open No.2004-35918, Japanese Patent Laid-Open No.2004-107786 and Japanese Patent Laid-Open No.H9-143785 to manufacture electro-deposited copper foil without roughening treatment, profile (Rzjis) value on the deposition side show a level exceeding 1.2 μm. In contrast, as shown in an embodiment, it will also become possible for electro-deposited copper foil related to the present invention to obtain a lower profile with surface roughness (Rzjis) on the deposition surface being not more than 0.6 μm by optimizing conditions. Here, no lower limit value is shown in particular, but the lower limit of profile is empirically around 0.1 μm.

In addition, brightness is used as an indicator showing smoothness of a deposition surface of electro-deposited copper foil used for flexible copper clad laminate related to the present invention. And brightness makes it possible to show difference clearly from conventional low profile electro-deposited copper foil. Method of measurement of brightness used in the present invention is to give light at incident angle 60° onto the surface of the copper foil specimen along the process flow direction (MD direction) of electro-deposited copper foil and measure intensity of light reflected in reflection angle of 60°. Equipment used for measurement is a digital multi-angle gloss meter VG-1D produced by Denshoku Industries Co., Ltd. Method for measuring brightness is based on JISZ 8741-1983. Consequently, as a result of tracing of the manufacturing method disclosed in the above described Japanese Patent Laid-Open No. 2004-35918, Japanese Patent Laid-Open No. 2004-107786 and Japanese Patent Laid-Open No. H9-143785 to manufacture electro-deposited copper foil with thickness of 12 μm, brightness [Gs (60°)] of the deposition surface obtained is in a range from around 250 to 380. In contrast, an electro-deposited copper foil related to the present invention apparently has brightness [Gs (60°)] exceeds 400 and has a smooth surface. Moreover, as shown in the embodiment, with optimization of conditions, it will become possible to get brightness [Gs (60°)] of 500 or more. Here, no upper limit value of brightness is determined as well and empirically it seems that around 780 may be an upper limit.

On such a smooth deposition surface, later-described surface treatment may follow to carry out roughening treatment and rust proofing treatment and the like to obtain such a surface treated copper foil comprising a roughening treatment surface with a profile lower than a conventional surface treated copper foil with low profile. And, using the surface treated copper foil to bond it to resin film, it is enough to obtain physical anchor effect to an appropriate extent and the relief in the bonding interface may be slight and therefore etching solution and the like hardly penetrate through the bonding interface so that deterioration in chemical resistance may also small.

And electro-deposited copper foil used for flexible printed wiring board related to the present invention comprises high mechanical properties. Tensile strength as received of not less than 33 kgf/mm², and tensile strength after heating (180° C.′ 60 minute in the atmosphere) of not less than 30 kgf/mm² also. In tracing of the manufacturing method disclosed in the above described Japanese Patent Laid-Open No. 2004-35918, Japanese Patent Laid-Open No. 2004-107786 and Japanese Patent Laid-Open No. 9-143785 to manufacture electro-deposited copper foil with thickness of 12 μm, almost all the foil show properties of tensile strength as received is not more than 33 kgf/mm² and tensile strength after heating (180° C.′ 60 minute in the atmosphere) is not more than 30 kgf/mm². Due to the tensile strength, some types are with no large value of tensile strength as received, are softened to impart tensile strength on the level of 20 kgf/mm² only by being heated through heating processing of 180° C.′ 60 minute at the time of undergoing conventional processing into a printed wiring board and are not appropriate for three-layer TAB tape products which will require flying lead to be formed. Accordingly, being heated and then tensile stress is applied, it may break easily very often. In contrast, electro-deposited copper foil related to the present invention having tensile strength as received is not less than 33 kgf/mm², more preferably not less than 37 kgf/mm², and has high mechanical properties with tensile strength after heating (180° C.′ 60 minute in the atmosphere) is not less than 30 kgf/mm², more preferably 33 kgf/mm². Moreover, as shown in the embodiment, with optimization of conditions, it is possible to have higher mechanical properties with tensile strength as received of not less than 38 kgf/mm², and tensile strength after heating (180° C.′ 60 minute in the atmosphere) of not less than 35 kgf/mm². Accordingly, it is appropriate to inner lead (flying lead) to be an IC chip mounting portion of three-layer TAB tape comprising device hole. That is, considering presence of inner lead (flying lead) in three-layer TAB tape, tensile strength as received and after heating is preferred to be higher. With tensile strength as received is not less than 33 kgf/mm² and tensile strength after heating (180° C.′ 60 minute in the atmosphere) is not less than 30 kgf/mm², general bonding for mounting devices is applicable. However, with tensile strength of the electro-deposited copper foil as received is not less than 37 kgf/mm² and tensile strength after heating (180° C.′ 60 minute in the atmosphere) is not less than 33 kgf/mm² and, moreover, with tensile strength as received is not less than 38 kgf/mm², and tensile strength after heating is not less than 35 kgf/mm², it is possible to critically increase bonding pressure of mounting devices stepwise.

Moreover, electro-deposited copper foil used for a flexible printed wiring board related to the present invention comprises good mechanical properties with elongation as received is not less than 5% and elongation after heating (180° C.′ 60 minute in the atmosphere) is not less than 8%. In tracing of the manufacturing method disclosed in the above described Japanese Patent Laid-Open No. 2004-35918, Japanese Patent Laid-Open No. 2004-107786 and Japanese Patent Laid-Open No. 9-143785 to manufacture electro-deposited copper foil with thickness of 12 μm, most of all film shows properties, that is, with elongation as received is less than 5% and elongation after heating (180° C. 60 minute in the atmosphere) is less than 7%. Indeed, even this level of elongation is sufficient for foil crack prevention at the time of carrying out processing to manufacture a printed wiring board and to form through holes with a mechanical drill. However, it is insufficient when considering prevention of crack occurrence in a wiring located in a bending portion at the time of manufacturing a flexible printed wiring board after laminating the electro-deposited copper foil with flexible base material such as polyimide resin film, aramide film and PET film together and bending it to use. Electro-deposited copper foil used for a flexible printed wiring board related to the present invention having good mechanical properties, that is, with elongation as received is not less than 5% and elongation after heating (180° C.′ 60 minute in the atmosphere) is not less than 8% and, therefore, elongation endurable against folding use of a flexible printed wiring board is achieved.

And a flexible printed wiring board related to the present invention is manufactured by using electro-deposited copper foil with the above described tensile strength and elongation, and after finishing the flexible printed wiring board manufacturing process, preferably tensile strength as received and elongation as received of electro-deposited copper foil peeled from the flexible printed wiring board are respectively not less than 25 kgf/mm² and not less than 10%. The reason why is that good folding resistance and the like can be assured as a flexible printed wiring board if those properties are fulfilled.

And an electro-deposited copper foil for flexible printed wiring board related to the present invention is preferably obtained by electro-deposition from copper electrolyte containing diallyl dimethyl ammonium chloride as quaternary ammonium salt polymer with a sulfuric acid system.

And, a method of electrolysis with copper electrolyte of a sulfuric acid system containing diallyl dimethyl ammonium chloride as quaternary ammonium salt polymer will be described in advance. And more preferably, it is preferable to use copper electrolyte of a sulfuric acid system obtained by adding diallyl dimethyl ammonium chloride as quaternary ammonium salt polymer having ring structure, 3-mercapto-1-propanesulfonic acid and chlorine. Using thus composed copper electrolyte of a sulfuric acid system, it will become possible to stable manufacturing of low profile electro-deposited copper foil to be used in the present invention. It is the most preferable that three components of obtained by adding 3-mercapto-1-propanesulfonic acid, quaternary ammonium salt polymer having ring structure and chlorine are present in copper electrolyte of a sulfuric acid system. But manufacturing yield of low profile electro-deposited copper foil gets unstable in case of lacking any component thereof.

Concentration of 3-mercapto-1-propanesulfonic acid in copper electrolyte of a sulfuric acid system to be used for manufacturing electro-deposited copper foil used for a flexible printed wiring board related to the present invention is preferably 3 ppm to 50 ppm, more preferably 4 ppm to 30 ppm and further preferably 4 ppm to 25 ppm. In the case where the 3-mercapto-1-propanesulfonic acid concentration is less than 3 ppm, the deposition surface will get rough and it will become difficult to obtain low profile electro-deposited copper foil. On the other hand, also in the case where the concentration of 3-mercapto-1-propanesulfonic acid exceeds 50 ppm, an effect onto the deposition surface of electro-deposited copper foil to be obtained getting flat and smooth is not improved but rather electrodeposited state gets unstable. Here, 3-mercapto-1-propanesulfonic acid described in the present invention is used to mean inclusion of 3-mercapto-1-propanesulfonate acid as well and the listed values of concentration are values subjected to 3-mercapto-1-propanesulfonate conversion as sodium salt. Here, concentration of 3-mercapto-1-propanesulfonic acid is concentration includes not only 3-mercapto-1-propanesulfonic acid but also modified substance in electrolyte such as dimmer of 3-mercapto-1-propanesulfonic acid and the like.

And, the concentration of quaternary ammonium salt polymer in copper electrolyte of a sulfuric acid system used for a method of manufacturing electro-deposited copper foil in the present invention is preferably 1 ppm to 50 ppm, more preferably 2 ppm to 30 ppm and further preferably 3 ppm to 25 ppm. Here, it is possible to use various types as quaternary ammonium salt polymer but, in consideration of an effect of forming low profile deposition surface, it is the most preferable to use a compound with nitrogen atoms being included in a part of pentagonal ring quaternary ammonium, in particular, diallyl dimethyl ammonium chloride.

And, in consideration of the relation with the above described 3-mercapto-1-propanesulfonic acid, concentration of diallyl dimethyl ammonium chloride in copper electrolyte of a sulfuric acid system is preferably 1 ppm to 50 ppm, more preferably 2 ppm to 30 ppm and further preferably 3 ppm to 25 ppm. Here, in the case when the concentration of diallyl dimethyl ammonium chloride in copper electrolyte of a sulfuric acid system is less than 1 ppm, in spite of how high the 3-mercapto-1-propanesulfonic acid concentration, the deposition surface of the electro-deposited copper foil may be rough. It may be difficult to obtain low profile electro-deposited copper foil. Even if the concentration of diallyl dimethyl ammonium chloride in copper electrolyte of a sulfuric acid system exceeds 50 ppm, a copper deposition will get unstable so as to make it impossible to obtain low profile electro-deposited copper foil.

Moreover, chlorine concentration in the above described copper electrolyte of a sulfuric acid system is preferably 5 ppm to 60 ppm and more preferably 10 ppm to 20 ppm. In the case where the chlorine concentration is less than 5 ppm, the deposition surface of electro-deposited copper foil will get rough so as to make it impossible to maintain the low profile. On the other hand, when the chlorine concentration exceeds 60 ppm, the matte side of electro-deposited copper foil will get rough and makes electro-deposition state unstable so as to make it impossible to form a low profile deposition surface.

As described above, the most important is a composition balance among 3-mercapto-1-propanesulfonic acid, diallyl dimethyl ammonium chloride and chlorine in the above described copper electrolyte of a sulfuric acid system and, when quantitative balance among them deviates from the above described range, the deposition surface of electro-deposited copper foil will get rough as a consequence so as to make it impossible to maintain the low profile.

Here, copper electrolyte of a sulfuric acid system described in the present invention is assumed to be to be solution with copper concentration of 50 g/l to 120 g/l and free sulfuric acid concentration with 60 g/l to 250 g/l.

And, in case of manufacturing electro-deposited copper foil in use of the above described copper electrolyte of a sulfuric acid system, it is preferable to set solution temperature to 20° C. to 60° C. to carry out electrolysis with current density of 30 A/dm² to 90 A/dm². The solution temperature is 20° C. to 60° C. and more preferably 40° C. to 55° C. In the case where the solution temperature is less than 20° C. the deposition speed decreases so that deviation of mechanical properties such as elongation, tensile strength and the like will get large. On the other hand, the solution temperature exceeding 60° C. may increases of water evaporation to lead big deviation of the solution concentration rapid. It makes impossible for the obtained electro-deposited copper foil to maintain good smoothness. In addition, the current density is 30 A/dm² to 90 A/dm² and more preferably 40 A/dm² to 70 A/dm². In the case where the current density is less than 30 A/dm², copper deposition speed is slow and inferior in industrial productivity. On the other hand, in the case where current density exceeds 90 A/dm², roughness of the deposition surface of the obtained electro-deposited copper foil gets large to make it impossible to exceed conventional low profile copper foil.

And, an electro-deposited copper foil related to the present invention is applicable as electro-deposited copper foil having undergone surface treatment of either one or more kinds selected from roughening treatment, rust proofing treatment and treatment with silane coupling agent on its deposition surface.

Here, for the roughening treatment, either method by attaching fine metal particles onto or by etching of the surface of electro-deposited copper foil for forming a roughened surface can be adopted. Here, a former method of attaching the fine metal particles may be exemplified by a method of attaching copper fine particles onto a matte side for forming in advance. That roughening treatment process is performed by a process for depositing and attaching fine copper particles onto a matte side of electro-deposited copper foil and a seal plating process for preventing those fine copper particles from dropping off.

For the process for depositing and attaching fine copper particles onto a matte side of electro-deposited copper foil, conditions for burnt plating are adopted as electrolytic conditions. Accordingly, solution concentration generally used for the process for depositing and attaching fine copper particles is set to low metal concentration so that burnt plating conditions are easily obtained. However, in electro-deposited copper foil used in the present invention, its deposition surface is flatter and has lower profile than a conventional low profile and therefore, even if the burnt plating is performed, sites on which current concentrate such as physical protrusions and the like are few, and therefore, fine copper particles can be attached for forming in an extremely fine and uniform state. Those burnt plating conditions will not be limited in particular, but are to be determined in consideration of characteristics of a production line. For example, if solution of a copper sulfate system is used, there adopted are such conditions and the like with concentration being 5 to 20 g/l for copper, 50 to 200 g/l for sulfuric acid, the other additives (a-Naphthoquinoline, dextrin, glue, thiourea and the like) corresponded with necessity, of 15 to 40° C. of solution temperature and 10 to 50 A/dm² of current density.

And, a seal plating process for preventing fine copper particles from dropping off is a process for depositing copper uniformly so as to cover fine copper particles under level plating conditions in order to prevent fine copper particles caused to be deposited and attached from dropping off. Accordingly, the solution similar with the one used in a bath for forming the above described drum foil can be used as a supply source of copper ions. Those level plating conditions will not be limited in particular but are those determined in consideration of characteristics of a production line. For example, if solution of a copper sulfate system is used, conditions are set to provide densities of 50 to 80 g/l on copper and 50 to 150 g/l on sulfuric acid, temperature of 40 to 50° C. and a current density of 10 to 50 A/dm² and the like.

Next, a method of forming rust proofing treatment will be described. That rust proofing treatment layer is formed to prevent a surface of an electro-deposited copper foil layer from oxidation and/or corrosion so as not to suffer from problems in process of manufacturing a copper clad laminate and a printed wiring board. A method used for rust proofing treatment causes no problem in adopting organic rust proofing using benzotriazole, imidazole and the like or inorganic rust proofing using zinc, chromate, a zinc alloy and the like. Rust proofing suitable for expected use of electro-deposited copper foil should be preferably selected. In case of organic rust proofing, one of methods from dipping, showering, electro-deposition and the like can be used for organic rust-proofing agent. In case of inorganic rust proofing, one of methods from depositing rust-preventive element on a surface of electro-deposited copper foil layer through electro-deposition or through so-called substitution deposition method and the like can be used. For example, for carrying out zinc rust proofing treatment, a zinc pyrophosphate plating bath, a zinc cyanide plating bath, a zinc sulfate plating bath and the like can be used. In a zinc pyrophosphate plating bath, concentration being 5 to 30 g/l for zinc, 50 to 500 g/l for potassium pyrophosphate, 20 to 50° C. of solution temperature, pH 9 to 12 and 0.3 to 10 A/dm² of current density may be applicable.

The type of rust proofing will not be limited as described above, but in the case of using electro-deposited copper foil of the present invention without roughening treatment, it is preferable to use the following rust proofing treatment in order to improve wettability of the copper foil surface against resin film as much as possible to enhance adhesion. That is, it is preferable to use a nickel-zinc alloy as rust proofing treatment layer. In particular, nickel-zinc alloy for forming a rust proofing treatment layer, it is preferable to use the composition containing 50 wt % to 99 wt % of nickel and 50 wt % to 1 wt % of zinc with unavoidable impurities. The reason why is that presence of nickel in rust proofing treatment layer can remarkably improve adhesion to base material. In case of rust proofing treatment layer formed by the nickel-zinc alloy with nickel content of less than 50 wt %, improvement in adhesion with respective kinds of base material will inferior. In addition, nickel may intensively remain after etching with content exceeds 99 wt %, which is not preferable. According to the research of the inventors, for electro-deposited copper foil with carrier foil comprising resin layer related to the present invention, the total deposition amount of nickel and zinc are desirably be in a range from 20 mg/m² to 100 mg/m² in case of forming a rust proofing treatment layer of nickel with zinc. In particular, forming a rust proofing treatment layer composed of the nickel-zinc alloy in advance, the electro-deposited copper foil will not be peeled off from its adhesive interface but become excellent in chemical resistance, moisture resistance or solder heat-resistance at the time when bonded onto a special substrate that will hardly assure bond strength. With the total deposition amount being less than 20 mg/m², rust proofing treatment layer in uniform thickness can not be obtained and deviation of bond strength will become large. On the other hand, when the total deposition amount exceeds 100 mg/m², etching residue of nickel may occur at the time of etching in forming a wiring, so it is not recommended.

And, it has been confirmed that the abundance in nickel amount will may improve bond strength, chemical resistance, moisture resistance and solder heat-resistance and the zinc amount increases may deteriorate chemical resistance and solder heat-resistance. And, in case of forming a rust proofing treatment layer made of a nickel-zinc alloy, it was proved to be practically preferable to set the rate of nickel with zinc thereof in a range of nickel:zinc=6:4 to 8:2 at the time when the total deposition amount of nickel and zinc is within 20 to 100 mg/m². The nickel ratio, which occasionally exceeds 80 wt %, may give rise to etching residues at the time forming a wiring. In addition, the zinc ratio, which occasionally exceeds 40 wt %, may deteriorate chemical resistance and solder heat-resistance.

In addition, the rust proofing treatment layer is also preferably composed by nickel-zinc alloy layer with chromate layer to be described later. Presence of a chromate layer improves corrosion resistance and, at the same time, may improve adhesion to a resin layer as well. For forming a chromate layer, any conventional method selected from substitution method or an electrolytic method.

And, silane coupling agent treatment improve adhesion to insulating layer after roughening treatment, rust proofing treatment and the like. Silane coupling agent to be used described herein will not limited in particular, but it may optionally selected from epoxy functional silane coupling agents, an amino functional silane coupling agents, a mercapto functional silane coupling agents and the like will become feasible in consideration of insulating layer to be used, plating solution to be used in a process of manufacturing printed wiring board and the like.

More specifically, besides major use of coupling agent similar with those used for glass cloth in prepreg for a printed wiring board, one or mixture selected from vinyl trimethoxysilane, vinyl phenyl trimethoxysilane, gamma-methacryloxypropyltrimethoxysilane, gamma-glycidoxypropyltrimethoxysilane, 4-glycidylbutyltrimethoxysilane, gamma-aminopropyltrimethoxysilane, N-b(aminoethyl)g-aminopropyltrimethoxysilane, N-3-(4-(3-aminopropoxy)butoxy)propyl-3-aminopropyltrimet hoxysilane, imidazole silane, triazine silane, gamma-mercapto propyltrimethoxysilane and the like can be used.

And, surface treated copper foil having undergone the above described desired surface treatment on its deposition surface is featured by bonding side to its resin film base comprising a low profile with surface roughness (Rzjis)=5 μm. Comprising such a low profile roughening treatment surface, not only acceptable adhesion against practical use at the time of being bonded with a resin film layer is assured but also good etching performance is assured. In addition, heat-resistance, chemical resistance and acceptable peel strength against practical use is also obtained.

Mode of manufacturing flexible copper clad laminate: using electro-deposited copper foil having been described above, a flexible copper clad laminate related to the present invention is manufactured. The flexible copper clad laminate described in the present invention is described as a concept including any of the above described three-layer flexible copper clad laminate or two-layer flexible copper clad laminate. And, the method of manufacturing those flexible copper clad laminate will not be limited in particular. Any of popular methods are preferably used.

In the case of three-layer flexible copper clad laminate, an adhesive layer is provided on the surface of resin film; the adhesive layer is made into a semi-cured stage and the adhesive layer is heated to get fluidized again; electro-deposited copper foil is laminated thereto and undergoes curing; and thereby a three-layer flexible copper clad laminate in a state of electro-deposited copper foil layer/adhesive layer/resin film layer is made.

And, a case of two-layer flexible copper clad laminate, casting method may be exemplified. It is obtained by coating a polyimide based varnish on the deposition surface of electro-deposited copper foil directly with known coating means such as a dye coater, a roll coater, a rotary coater, a knife coater, a doctor blade and the like, and thereafter heating and drying the varnish. No particular limit to the polyimide based varnish to be used here will be required. In general, it is possible to widely use polyamic acid varnish obtained by causing an agent of diamine systems and acid anhydride to react and polyimide resin varnish imidized by causing polyamic acid to undergo chemical reaction under a state of a solution, and the like. That is, acid anhydride preferably undergoes component selection appropriately as far as resin of polyimide systems with desired composition is obtained with heating and drying and trimellitic anhydrides, pyromellitic dianhydrides, biphenyl tetracarboxylic dianhydrides, benzophenone tetracarboxylic dianhydrides and the like are used but no particular limit is deemed necessary. And as an agent of diamine systems, one type or not less than two types of phenylenediamine, diaminodiphenylmethane, diaminodiphenylsulfon, diaminodiphenylether and the like can be appropriately combined and be used. In addition, it should be made clear that those varnishes also include composite varnishes of polyimide systems subjected to addition of polyamide-imide resin, bismaleimide resin, polyamide resin, epoxy resin, acrylic resin and the like as far as they satisfy required quality at the time when they are taken as a flexible printed wiring board.

Flexible printed wiring board related to the present invention: using a flexible copper clad laminate related to the present invention having been described above, a flexible printed wiring board with high qualities can be obtained. A flexible printed wiring board described here is described as a concept including a film carrier tape.

The method of processing a flexible copper clad laminate to get a printed wiring board will not be limited in particular. A popular etching process may be preferably used. Accordingly, a detailed description here will be omitted. Thus, even using a popular etching process, in particular, using a flexible copper clad laminate related to the present invention, yield in manufacturing flexible printed wiring boards in a film carrier tape shape comprising a fine pitch wiring with wiring pitch of not more than 35 μm, preferably not less than 30 μm among flexible printed wiring boards are improved dramatically.

Here, as an example of a method of manufacturing a flexible printed wiring board, a method of manufacturing a film carrier tape will be described just in the case. A film carrier tape formed into a wiring shape consists of resin film, a wiring pattern formed on the surface thereof and an insulating resin protection layer such as a solder resist layer or cover lay layer where terminal portions are arranged in the wiring pattern so as to be exposed.

Polyimide film, polyimide amide film, polyester film, polyphenylene sulfide film, polyetherimide film, fluorocarbon resin film, liquid crystal polymer film and the like can be used as resin film. That is, those sheets of resin film has chemical resistance to such an extent that will not be attacked by etching solution used at the time of etching or an alkaline solution used at the time of cleaning and the like. And they have heat resistance to such an extent that will not cause any thermal deformation due to heating at the time of mounting electronic devices, and the like. In those resin films having such properties, it is preferable, in particular, to use polyimide film.

Such resin film has average thickness of 5 to 150 μm, preferably of 5 to 125 μm and preferably in particular of 25 to 75 μm. Required holes or openings such as sprocket holes, device holes, folding slits, positioning holes and the like are made by punching.

And the wiring pattern is formed by etching a copper layer (electro-deposited copper foil layer in the present invention) arranged on a surface of resin film as described above. Thickness of the above described copper layer falls normally within a range of 2 to 70 μm and preferably within a range of 6 to 35 μm.

An electro-deposited copper foil as described above can be arranged on the surface of resin film without using any adhesive but an adhesive layer can be formed for bonding. An adhesive layer used for adhesion of electrically conductive metal foil can be formed by using, for example, an adhesive of epoxy resin, polyimide resin, acryl resin and the like. Thickness of such an adhesive layer falls normally within a range of 1 to 30 μm and preferably within a range of 5 to 20 μm.

And the wiring pattern is formed by etching electro-deposited copper foil layer formed as described above on the surface of resin film. That is, a wiring pattern is formed as followings. UV photosensitive liquid etching resist is coated on the surface of a electro-deposited copper foil layer and dried at 70° C. to 130° C. for one to ten minutes to form an etching resist layer. Exposing and developing the etching resist layer to form an etching resist pattern to form a desired resist pattern. Selectively etch the electro-deposited copper foil layer against the resist pattern. This is described just in case, but a dummy pattern is provided occasionally which is not electrically connected in the region where no wiring pattern is formed for various purposes in general. And, in case of a COF tape in use of a two-layer flexible copper clad laminate, a manufacturing method called “leftover copper” is adopted in general. An electro-deposited copper foil around the sprocket hole which is neither etched nor removed but is left as is for a purpose of reinforcement.

Then, a wiring pattern formed on the resin film surface is covered by a resin protection layer with terminal portions exposed. And, before a resin protection layer is formed in accordance with necessity, plating treatment (occasionally called “prior plating treatment”) may be carried out so as to cover the formed wiring pattern for a purpose of oxidization prevention and the like.

Here, in case of forming plating layer described above, one selected from a tin plating, a gold plating, a nickel-gold plating, a solder plating, a lead-free solder plating, a lead plating, a nickel plating, a zinc plating, a chromium plating and the like is preferred. In addition, those plating layers may be a composite layer subjected to plating of a plurality layers. In particular, one of tin plating, gold plating, nickel plating and nickel-gold plating is preferable in the present invention. The reason why is that they are excellent in bonding stability at the time surface mounting of electronic devices.

Thickness of such a plating layer can be appropriately selected based on plating type but is set to thickness within a range normally of 0.005 to 5.0 μm and preferably of 0.005 to 3.0 μm. Here, after tin plating, curing of 70° C. to 200° C. for 0.3 hours to 3.0 hours is performed in general. In addition, after plating the full surface of a wiring (to be referred to as “first plating treatment” below), form a resin protection layer with exposed terminal portions, the metal plating same as the first plating or heterogeneous metal plating (second plating treatment) may be performed further again in the terminal portions where portions exposed from the resin protection layer. As a method of forming the plating layer, any of electrolytic method and electro-less method may be used.

After forming such a plating layer as described above in accordance with necessity, a resin protection layer is formed to cover a wiring pattern and a resin film layer being present between the wiring pattern, leaving terminal portions of the wiring pattern. That resin protection layer can be formed by screen printing technologies, for example, by coating desired portions with solder resist ink of an epoxy system, a urethane system, a polyimide system and the like and curing at 100° C. to 180° C. for 30 minutes to 300 minutes. A resin film (cover lay film) has an adhesive layer having desirable shape by punching and the like and is laminated to the resin film.

And, in the case without prior plating, a plating layer (hereinafter to be referred to as “bump plating layer”) is formed on a wiring (lead) surface exposed from the resin protection layer after forming of the resin protection layer. The plating (occasionally to be referred to as “post plating”) makes it easy electrical connection between the bump electrodes formed on the electronic devices and the outer leads of the film carrier, when the electronic devices are mounted on the film carrier tape. And also, the plating works to obtain electrical connection between the film carrier and the electronic equipments, when the film carrier (semiconductor device) on which the electronic device is mounted is equipped on the electronic equipments.

For forming the bump plating layer, one selected from a tin plating, a gold plating, a silver plating, a nickel-gold plating, a solder plating, a lead-free solder plating, a palladium plating, a nickel plating, a zinc plating, a chrome plating and the like can be used. In addition, the plating layer is a single layer of the above described plating layer and may be a composite plating layer with a plurality of plating layers having been stacked. In addition, it should be made clear here that the bump plating layer as described above may cause diffusion within metals (copper as a wiring and metal as a foundation plating) in a stacked state after post heating and the like.

The bump plating layer described here is to be formed in use of conventional plating method such as an electrolytic method or electro-less method and the like similar with the previous plating. And, average thickness of the bump plating layer is different in product specifications and type of metal as a plating layer but normally falls within a range of 0.3 μm to 12 82 m. Similar with in the case of the above described tin plating and prior plating, curing is carried out after post plating as well. Here, in case of forming a plurality of plating layers, the above described average thickness is total thickness of plating layer after it is formed. As described above, manufacturing of a film carrier tape is finished. In case of the present invention, a resin layer is removed from a manufactured film carrier tape by chemicals such as polyimide etching agent and the like and a copper layer or a plated copper layer with width of 2.0 mm to 5.0 mm and length of 80 mm to 100 mm was obtained from the dummy pattern or the leftover copper portions. And, in a tensile test carried out on the copper foil, it is found that the tensile strength was within a range of 25 kgf/mm² to 30 kgf/mm² and elongation was within a range of 10% to 15%. Here, a tensile test is carried out on such a tin-plated copper layer that is obtained as a copper layer subjected to removing the plating layer with a commercially available alkaline tin stripper.

Embodiments of manufacturing a flexible copper clad laminate related to the present invention and manufacturing a COF tape including a wiring with a pitch of 30 μm will be shown below. And, a conventional low profile copper foil is manufactured so that manufacturing yield in case of manufacturing a similar with COF tape using that will be compared.

Here, the COF tape will be described a little more in detail. Conventionally, a flexible printed wiring board is required to have a fine pitch wiring formed and mount chip devices such as IC and the like thereon, and a film carrier tape such as a three-layer TAB (tape automated bonding) tape, an ASIC (application specific integrated circuit) tape and the like have been used. Among them, a chip on film (COF) mountable in narrow space in an electronic appliance has been attracting attention as a technology corresponding with down-sizing. Since the COF type film carrier tape has no flying lead as inner lead, it is not required to have device hole formed as in a three-layer TAB tape. That is, all the sites of a wiring are supported by resin film being the base material. Accordingly, since resin film is present as a support of a wiring in a device mounting region, even when it is subjected to fining the wiring in the devices mounting portion, it is possible to assure required wiring strength at the time of carrying out bonding of chip devices, imparting a feature the fine pitching across the wiring becomes easier. Mode of semiconductor device related to the present invention: A semiconductor device related to the present invention is a flexible printed wiring board or film carrier tape obtained by using above described flexible copper clad laminate which mount chip devices such as IC and the like being thereon and undergoes resin encapsulation so that a semiconductor devices with high quality of wiring excellent in folding endurance can be provided.

### EMBODIMENT 1

Manufacturing of electro-deposited copper foil: In the present embodiment, electro-deposited copper foil with thickness of 12 μm was obtained by using solution of a copper sulfate system, copper concentration of 80 g/l, free sulfuric acid of 140 g/1, 3-mercapto-1-propanesulfonic acid concentration of 4 ppm, diallyl dimethyl ammonium chloride (UNISENCE FPA100L produced by SENKA corporation) concentration of 3 ppm, chloride concentration of 10 ppm and solution temperature of 50° C. and carrying out electrolysis at current density of 60 A/dm². One side of the electro-deposited copper foil is a shiny side (Ra=1.02 μm) which is mirror shape of a titanium made electrode. The other side is a deposition surface with roughness of Rzjis=0.53 μm, Ra=0.09 μm, brightness of [Gs (60°) ] 669. Tensile strength as received is 39.9 kgf/lm², tensile strength after heating is 35.2 kgf/M², elongation as received is 7.6% and elongation after heating is 14.3%.

And as surface treatment on the above described electro-deposited copper foil, fine copper particles are deposited on matte side to form a roughening treatment surface. Before forming the roughening treatment surface, the surface of the electro-deposited copper foil is cleaned through acid pickling. As the acid pickling condition, dilute sulfuric acid solution with concentration of 100 g/l, solution temperature of 30° C. was used and immersion for 30 seconds.

After acid pickling, fine copper particles are formed on a matte side of electro-deposited copper foil, by depositing and attaching fine copper particles onto a matte side followed by seal plating for preventing those fine copper particles from dropping off. In the step of depositing and attaching the fine copper particles, solution of a copper sulfate system was prepared in concentrations 7 g/l for copper and 100 g/l for sulfuric acid, and electrolysis was carried out at 25° C. of solution temperature and with 10 A/dm² of current density for 10 seconds.

And when fine copper particles are attached to and formed on the matte side, a level plating process for preventing fine copper particles from dropping off, deposition of copper uniformly to cover fine copper particles was carried out under level plating conditions. Here, as level plating conditions, copper sulfate solution underwent electrolysis for 20 seconds under conditions with concentration of 60 g/l for copper, 150 g/l for sulfuric acid, 45° C. for solution temperature and 15 A/dm² for current density.

After roughening treatment, rust proofing treatment was carried out on both sides of the copper foil. Here, inorganic rust proofing under conditions described below was adopted. A zinc sulfate bath was used to carry out zinc rust proofing treatment under 70 g/l of sulfuric acid concentration, 20 g/l of zinc concentration, 40° C. of solution temperature and 15 A/dm² of current density.

Moreover, in case of the present embodiment, a chromate layer was formed onto the above described zinc rust-proofing layer by electrolysis. Electrolytic conditions at the time were set to 5.0 g/l of chromium acid solution, pH 11.5, and 35° C. of solution temperature, 8A/dm² of current density and 5 seconds of electrolytic time.

After the rust proofing treatment followed by rinsing with water, silane coupling agent was absorbed immediately onto the rust proofing layer of the roughened surface in a silane coupling agent treatment bath.

After the silane coupling agent treatment, finally, the electro-deposited copper foil was heated in a furnace in the atmosphere so that the foil temperature reaches 140° C. for 4 seconds with an electric heater, evaporating water and promoting condensation reaction of the silane coupling agent to finish an electro-deposited copper foil. Roughness of the surface with roughening treatment after the surface treatment was Rzjis=4.6 μm. Fabrication of flexible copper clad laminate: the polyimide precursor varnish containing commercially available polyamic acid solution was coated on the above described electro-deposited copper foil surface subjected to roughening treatment and then heated to polymerize it. Then, a polyimide resin film layer by a casting method with 40 μm thickness was formed. Consequently, a two-layer flexible copper clad laminate consisting of an electro-deposited copper foil layer with thickness of approximately 12 μm and a polyimide resin film layer (base film layer) with thickness of 40 μm was manufactured. Manufacture of COF tape: sprocket holes and through holes as required were formed by punching onto the above described flexible copper clad laminate comprising predetermined width to be a tape (hereinafter, for a purpose of description, this will be called “tape like flexible copper clad laminate”.).

The tape like flexible copper clad laminate wound on a reel was unwound to form a wiring pattern in the etching line for COF tape manufacturing and to form a leftover copper portion around the sprocket holes for reinforcement. Here, using liquid resist onto the copper foil surface and curing at 100° C., a copper etching resist layer was formed. And, an exposure pattern was printed onto the etching resist layer and was developed to form a resist pattern. The exposure pattern at the time is designed to form a wiring including a portion thereof with lead width of 15 μm and lead pitch of 30 μm (L/S=15/15). That is a wiring with the lead width corresponding to 50% of the lead pitch.

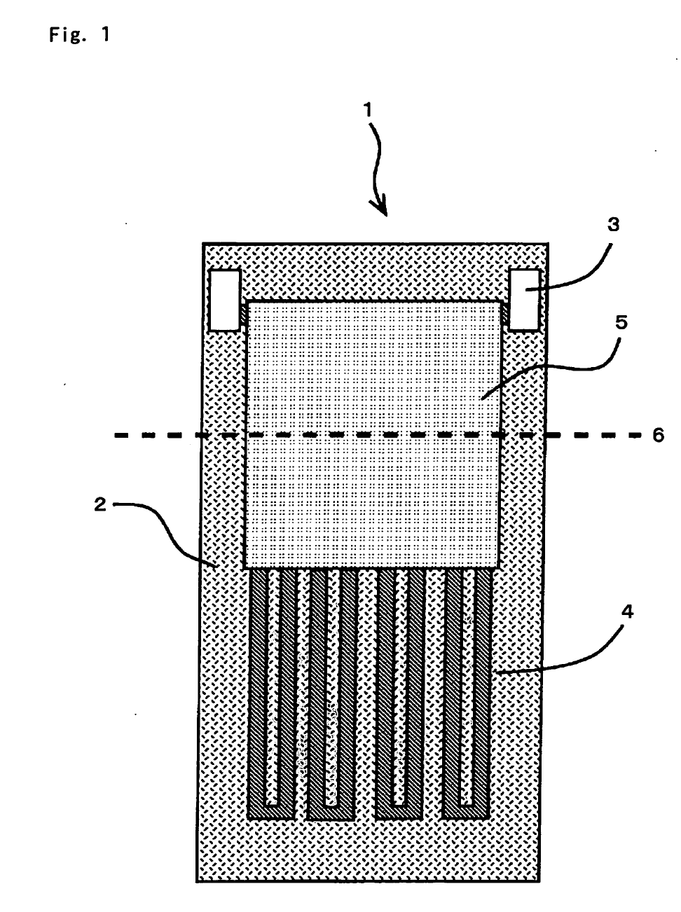

Thereafter, copper etching was carried out with cupric chloride solution in conventional method as followings. The resist pattern was removed followed by sufficient rinsing with water was carried out. Subsequently, wiring and leftover copper portion was electro-less plated with tin to have tin layer thickness of 0.45 μm followed by thermal treatment at 135° C. And, as shown in FIG. 1, the upper region of the wiring was coated with liquid solder resist through a screen printing method and cured at 120° C. Thus a film carrier tape (COF tape) for mounting electronic devices thereon was obtained. COF tape is examined in test specimen 1 comprises comb-shaped wiring 4 which is electrically conductive from terminal portion 3 on the surface of polyimide resin base 2, having the upper region of comb-shaped wiring 4 thereof is covered with solder resist 5.

COF tape evaluation result: Consequently, leftover etching could not be formed on any product but a wiring with width of 15 μm was formed and wiring pitch of 30±0.001 μm was obtained. And, in reflection of manufacturing deviation to potentially take place in a popular process, manufacturing yield was 96%. In addition, polyimide resin film layer was inspected by an automatic optical inspection apparatus (AOI) to find good optical transparency.

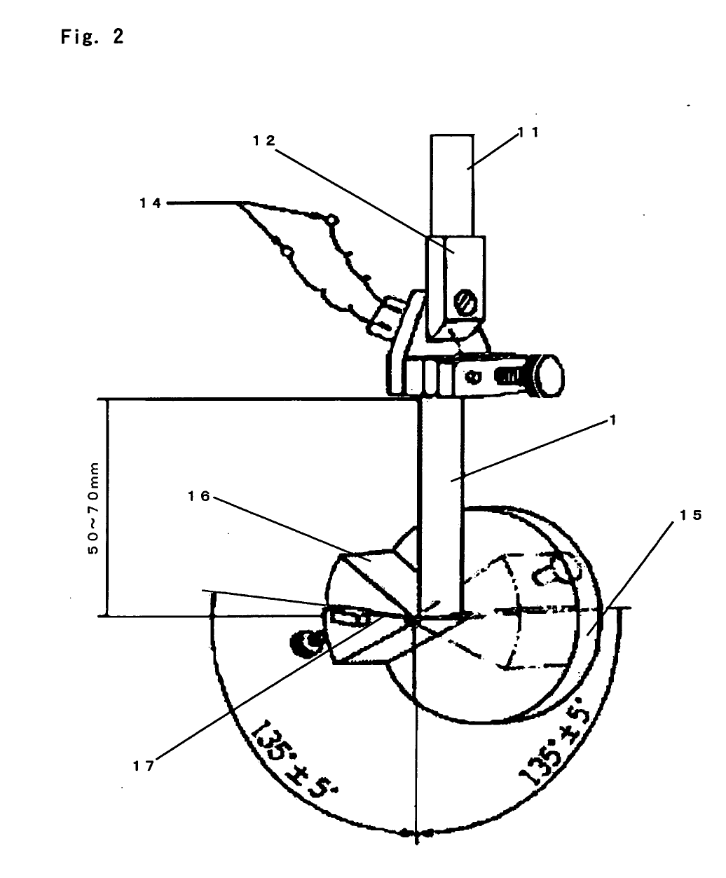

Moreover, in order to check folding endurance of the COF tape, in use of an MIT folding endurance tester shown in FIG. 2, a load of 100 gf was loaded to carry out a predetermined number of bends (repeated bends) in folding position 6 (position where solder resist layer 5 was coated) of a test specimen shown in FIG. 1 to confirm a break state in the wiring of comb-shaped wiring 4. Consequently, the average number of bends in case of R (0.5 mm) was 53 times. Here, MIT folding endurance tester 10 will be described briefly. Test sample fixing portion 12 which can be loaded with a load is attached to the tip of plunger 11. And, the test specimen fixing portion 12 holds and fixes the middle portion of rectangular test specimen 1 shown in FIG. 1. At the time, the leading edge side where terminal portion 3 of measurement test specimen 1 is present protrudes outward from test specimen fixing portion 12 and brings the terminal portion 3 and lead 14 into connection to detect an occurrence of electrical break. On the other hand, the other end side of measurement test specimen 1 is fixed with folding apparatus 16 which is fixed and arranged on folding apparatus mounting stage 15. Folding apparatus 16 has circular shape in two-dimensional view with slit 17, which is made to be separable from its center portion, for clipping and fixing measurement test specimen 1. That folding apparatus mounting stage 15 swings left and right by an equal angle and thereby the folding apparatus looks swinging left and right by an equal angle so as apply a folding load in such a state that measurement test specimen 1 is loaded with a tensile load. Here, strictness as folding tests varies due to the level of R in the forefront end portion of folding apparatus 16 and a load at the time of measurement.

In addition, removing polyimide resin film layer with a commercially available polyimide etching agent, tin plated copper foil with width of 2.0 mm and length of 80 mm was obtained from a leftover copper portion of the COF tape. And, removing tin plated layer from the copper foil with a commercially available tin stripper, a tensile test was carried out. Consequently, tensile strength shows 27 kgf/mm² and elongation shows 12%.

### EMBODIMENT 2

In this embodiment, for manufacturing electro-deposited copper foil of Embodiment 1, roughening treatment is omitted and a zinc-nickel alloy rust proofing layer described below was adopted as rust proofing treatment layer. As conditions for zinc-nickel alloy plating, electrolysis was carried out under conditions in use of nickel sulfate with nickel concentration of 0.3 g/l, in use of zinc pyrophosphate with zinc concentration of 2.5 g/l, potassium pyrophosphate of 100 g/l at solution temperature of 40° C. to form a zinc-nickel alloy plating layer containing 65 wt % of nickel and 35 wt % of zinc (total deposition amount of 36 mg/M²). And chromate treatment was carried out similar with Embodiment 1. Since the following process is similar with Embodiment 1, description thereof will be omitted here.

COF tape evaluation result: Film carrier tape (COF tape) for mounting electronic devices obtained with the embodiment was evaluated. Consequently, leftover etching was not formed in any product but a wiring with width of 15 μm was formed and wiring pitch of 30±0.001 μm was obtained. And, in reflection of manufacturing deviation to potentially take place in a popular process, manufacturing yield was 98%. In addition, polyimide resin film layer was inspected by an automatic optical inspection apparatus (AOI) to find good optical transparency.

Moreover, in order to check folding endurance properties of the COF tape, measurements similar with Embodiment 1 was carried out and consequently, the average number of bends in case of R (0.5 μm) was 56 times. In addition, tensile strength and elongation measured similar with Embodiment 1 were respectively 28 kgf /mm² and 14%.

### COMPARATIVE EXAMPLE 1

Manufacturing of electro-deposited copper foil: As a trace of embodiment 1 disclosed in Japanese Patent Laid-Open No. 2004-35918, copper sulfate (reagent) and sulfuric acid (reagent) are dissolved into pure water to obtain copper sulfate (5-hydrate conversion) concentration of 280 g/l and free sulfuric acid concentration of 90 g/l; copolymer of diallyl dialkyl ammonium chloride and sulfur dioxide (trade name: PAS-A-5, average molecular weight of 4000, produced by Nitto Boseki Co., Ltd. ) concentration of 4 ppm; polyethylene glycol (average molecular weight of 1000) concentration of 10 ppm and 3-mercapto-1-propanesulfonic acid concentration of 1 ppm were adjusted. And moreover, sodium chloride was add to adjust chloride concentration of 20 ppm; to finish sulfuric acidic base copper sulfate solution for copper electrolytic plating was prepared.

And as a cathode, a titanium plate electrode was used and its surface was polished with polishing paper of No. 2000. The surface roughness was adjusted to 0.20 μm by Ra. And, electrolysis was carried out on the above described electrolyte at solution temperature of 40° C. and current density of 50 A/dm² to obtain electro-deposited copper foil with thickness of 12 μm by using lead anode. One side of the electro-deposited copper foil is a shiny side (Ra=1.02 μm) with mirror shape of a titanium made electrode and the other side was a deposition surface roughness of Rzjis=0.85 μm, Ra=0.16 μm, rightness of [Gs (60°)] 283, tensile strength as received of 36.2 kgf/mm², tensile strength after heating of 32.4 kgf/mm², elongation as received of 4.0% and elongation after heating of 5.6%.

Thereafter similar with Embodiment 1, electro-deposited copper foil obtained was subjected to roughening treatment and rust proofing treatment. Roughness of the surface after roughening treatment was Rzjis=4.5 μm.

Subsequently, similar with Embodiment 1, a flexible copper clad laminate was manufactured; a wiring pattern with 30 μm pitch was formed; and thereby film carrier tape (COF tape) for mounting electronic devices was obtained.

COF tape evaluation result: film carrier tape (COF tape) for mounting electronic devices obtained with the comparative example was evaluated. Consequently, leftover etching could not be formed in any product. And, in reflection of manufacturing deviation to potentially take place in a popular process, manufacturing yield was 80%. In addition, there was no problem with optical transparency of polyimide resin film layer when inspected by an automatic optical inspection apparatus (AOI).

Moreover, in order to check folding endurance properties of the COF tape, confirmation similar with Embodiment 1 was carried out and the average number of bends in case of R (0.5 mm) was 29 times. In addition, tensile strength and elongation measured similar with Embodiment 1 were respectively 22 kgf/mm² and 7%.

### COMPARATIVE EXAMPLE 2

manufacturing of electro-deposited copper foil: In the present comparative example, electro-deposited copper foil with thickness of 12 μm was obtained by using, as copper electrolyte of a sulfuric acid system, solution with copper concentration of 80 g/l, free sulfuric acid of 140 g/l, diallyl dimethyl ammonium chloride (UNISENCE FPA100L produced by SENKA corporation) concentration of 4 ppm, chloride concentration of 15 ppm and solution temperature of 50° C. and carrying out electrolysis at current density of 60 A/dm². One side of the electro-deposited copper foil was a shiny side (Ra=1.02 μm) with mirror shape of a titanium made electrode and the other side was a deposition surface roughness of Rzjis=3.6 μm, Ra=0.55 μm, brightness of [Gs (60°)] 0.7, tensile strength as received of 40.5 kgf/mm², tensile strength after heating of 39.5 kgf/mm², elongation as received of 3.6% and elongation after heating of 4.4%.

Thereafter similar with Embodiment 1, electro-deposited copper foil obtained was subjected to roughening treatment and rust proofing treatment. Roughness of the surface after the surface treatment with roughening treatment was Rzjis=8.2 μm.

Subsequently, similar with Embodiment 1, a flexible copper clad laminate was manufactured; a wiring pattern was formed; and thereby film carrier tape (COF tape) for mounting electronic devices was obtained. COF tape evaluation result: film carrier tape (COF tape) for mounting electronic devices obtained with the comparative example was evaluated. Consequently, etching was not carried well in any product, deviation in wiring width was big and, therefore, it was difficult to form a wiring with pitch of 30 μm on an industrial level. However, there was no problem with optical transparency of polyimide resin film layer when inspected by an automatic optical inspection apparatus (AOI).

Moreover, in order to check folding endurance properties of the COF tape, measurements similar with Embodiment 1 was carried out and the average number of bends in case of R (0.5 mm) was 13 times. In addition, tensile strength and elongation measured similar with Embodiment 1 were respectively 25 kgf/mm² and 5%.

### COMPARATIVE EXAMPLE 3

Manufacturing of electro-deposited copper foil: In the present comparative example, electro-deposited copper foil with thickness of 12 μm was obtained by using, as copper electrolyte of a sulfuric acid system, solution with copper concentration of 80 g/l, free sulfuric acid of 140 g/l, diallyl dimethyl ammonium chloride (UNISENCE FPA100L produced by SENKA corporation to be used) concentration of 4 ppm, low molecular weight glue (number average molecular weight of 1560:6 ppm), chloride concentration of 15 ppm and solution temperature of 50° C. and carrying out electrolysis at current density of 60 A/dm². One side of the electro-deposited copper foil was a shiny side (Ra=1.02 μm) with mirror shape of a titanium made electrode and the other side was a deposition surface roughness of Rzjis=3.59 μm, Ra=0.54 μm, brightness of [Gs (60°)] 1.0, tensile strength as received of 38.6 kgf/mm², tensile strength after heating of 37.4 kgf/mm², elongation as received of 4.6% and elongation after heating of 4.8%.

Thereafter similar with Embodiment 1, electro-deposited copper foil was obtained subjected to roughening treatment and rust proofing treatment. Roughness of the surface after the surface treatment with roughening treatment was Rzjis=8.0 μm.

Subsequently, similar with Embodiment 1, a flexible copper clad laminate was manufactured; a wiring pattern was formed; and thereby film carrier tape (COF tape) for mounting electronic devices was obtained.

COF tape evaluation result: Film carrier tape (COF tape) for mounting electronic devices obtained with the comparative example was evaluated. Consequently, etching was not carried well in any product, deviation in wiring width was big and, therefore, it was difficult to form a wiring with pitch of 30 μm on an industrial level. However, there was no problem with optical transparency of polyimide resin film layer when inspected by an automatic optical inspection apparatus (AOI).

Moreover, in order to check folding endurance properties of the COF tape, measurements similar with Embodiment 1 was carried out and the average number of bends in case of R (0.5 mm) was 15 times. In addition, tensile strength and elongation measured similar with Embodiment 1 were respectively 24 kgf/mm² and 6%.

### COMPARISON BETWEEN EMBODIMENTS AND COMPARATIVE EXAMPLES

The above described embodiments and comparative examples will be compared. Results from comparative examples and embodiments into comparison will be described below.

Comparison between embodiments and comparative examples: At first, difference in electro-deposited copper foil used in embodiments and comparative examples will be described. Comparing deposition surface roughness in embodiments with that in comparative examples, difference between deposition surface roughness of electro-deposited copper foil related to the present invention described in embodiments and deposition surface roughness of electro-deposited copper foil of comparative example 1 is not big. And even in comparison as electro-deposited copper foil having undergone roughening treatment, difference in roughness between embodiments and comparative example 1 is small. That is, from examination based on profile (for example, Rzjis) measured with a roughness meter of a stylus system, extremely good low profile was achieved on electro-deposited copper foil of comparative example 1. However in comparison with brightness, comparative example 1 shows 283, brightness of each embodiment shows completely different value of 669. Based thereon, compared with electro-deposited copper foil of comparative example 1, electro-deposited copper foil obtained in embodiments has a deposition surface smooth and closer to a mirror surface. And, also in view of properties, it is apparent the each electro-deposited copper foil of embodiments is superior to the electro-deposited copper foil of comparative example 1.

And the electro-deposited copper foil obtained in comparative example 2 is for checking effects in case of lacking 3-mercapto-1-propanesulfonic acid in copper electrolyte to be used for manufacturing. As apparent from the results, in the case without 3-mercapto-1-propanesulfonic acid in copper electrolyte, it is apparent that the low profiling effect on electro-deposited copper foil is not attainable. And, in terms of brightness, it is apparent that it gets extremely low since it shows a matte surface, and for mechanical property, elongation is low. And it can be understood that the property is completely not acceptable for manufacturing film carrier tape for electronic devices mounting.

Moreover, comparative example 3 is for in case of checking effects of additive in copper electrolyte, low molecular glue instead of 3-mercapto-1-propanesulfonic acid. As apparent from the above results, in case of containing low molecular glue instead of 3-mercapto-1-propanesulfonic acid in copper electrolyte, it is apparent that low profiling effect on electro-deposited copper foil is not attainable. And, further in terms of brightness, it is apparent that it gets extremely low since it shows matte surface, and for mechanical property, elongation is low.

As described above, it will become apparent from comparison between embodiments and comparative examples that difference in electro-deposited copper foil to be used for manufacturing a flexible copper clad laminate show remarkable difference in etching performance of wiring, elongation of wiring and folding endurance when it is processed in making a flexible printed wiring board. At first, in comparison between embodiments each other, a two-layer flexible copper clad laminate is manufactured with electro-deposited copper foil subjected to roughening treatment in Embodiment 1. In Embodiment 2, a two-layer flexible copper clad laminate is manufactured with electro-deposited copper foil, with omission of roughening treatment. Comparing Embodiment 2 with Embodiment 1, Embodiment 2 without roughening treatment is higher in manufacturing yield on COF tape and a little better in folding endurance.

And, in view of manufacturing yield on a COF tape and the like on each comparative example, the manufacturing yield shown is lower than the embodiments and it is apparent that capability of forming fine pitch wiring with pitch lower than 35 μm is inferior to the embodiments. In particular, it is apparent that comparative example 2 and comparative example 3 cannot extend productivity with industrially profitability.

A flexible copper clad laminate related to the present invention is formed by applying electro-deposited copper foil comprising lower profile and higher mechanical strength compared with low profile electro-deposited copper foil having been conventionally supplied in the market. The electro-deposited copper foil may be a surface treated copper foil with lower profile far from a conventional foil level and it can control good adhesion to base film such as resin film and the like even in the case where the deposition surface has roughening treatment and rust proofing treatment. Accordingly, the flexible copper clad laminate related to the present invention is preferable for forming the fine pitch wiring such as a tape automated bonding substrate (three-layer TAB tape) or a chip-on-film substrate (COF tape) comprising wiring pitch of not more than 35 μm. In addition, electro-deposited copper foil to be used in the flexible copper clad laminate related to the present invention will have roughness of the matte side lower than the roughness of a shiny side and the both surfaces have glossy and smooth surfaces. Accordingly, even in a folding endurance test, good properties is obtained as well and are useful in the field of flexible printed wiring board and the like to be used under a folded state on the occasion of use.

What is claimed is:

1. A flexible copper clad laminate composed of electro-deposited copper foil attaching to resin film, which is characterized in that
a deposition surface of said electro-deposited copper foil comprises a low profile glossy surface and its surface roughness (Rzjis) is not more than 1.5 μm and its brightness (Gs (60°)) is not less than 400, and the deposition surface is attaching to the resin film.

2. The flexible copper clad laminate according to claim 1, which is characterized in that
tensile strength as received of said electro-deposited copper foil used is not less than 33 kgf/mm² and tensile strength after heating (180° C.×60 minute in the air) is not less than 30 kgf/mm².

3. The flexible copper clad laminate according to claim 1, which is characterized in that
elongation as received of said electro-deposited copper foil used is not less than 5% and elongation after heating (180° C.×60 minute in the air) is not less than 8%.

4. The flexible copper clad laminate according to claim 1, which is characterized in that
said electro-deposited copper foil used is obtained by electrolysis of copper electrolyte of a sulfuric acid system which contains diallyl dimethyl ammonium chloride as quaternary ammonium salt polymer.

5. The flexible copper clad laminate according to claim 1, which is characterized in that
said electro-deposited copper foil used which is performed one or more kinds of surface treatment selected from roughening treatment, rust proofing treatment and silane coupling agent treatment on its deposition surface.

6. The flexible copper clad laminate according to claim 5, which is characterized in that
deposition surface of said electro-deposited copper foil used has a low profile and its roughness (Rzjis) is not more than 5 μm after a surface treatment.

7. A flexible printed wiring board, which is characterized in that
it is obtained by using the flexible copper clad laminate according to claim 1.

8. The flexible printed wiring board according to claim 7, which is characterized in that
tensile strength and elongation of the electro-deposited copper foil in a flexible printed wiring board after manufacturing process are respectively not less than 25 kgf/mm² and not less than 10%.

9. A film carrier tape of the flexible printed wiring board obtained by using the flexible copper clad laminate according to claim 1, which is characterized in that
the formed wiring comprises a fine pitch wiring and the pitch is not more than 35 μm.

10. The film carrier tape according to claim 9,
wherein said wiring is obtained by laminating a electro-deposited copper foil with a low profile deposition surface and its surface roughness (Rzjis) is not more than 1.5 μm and its brightness (Gs (60°)) is not less than 400, to a resin film followed by etching.

11. Semiconductor device, which is characterized in that
it is obtained by using the flexible copper clad laminate according to claim 1.

12. A method of manufacturing the flexible copper clad laminate according to claim 1, which is characterized in that
a resin film layer is formed on the low profile glossy surface of electro-deposited copper foil with its surface roughness (Rzjis) being not more than 1.5 μm and its brightness (Gs (60°)) being not less than 400.

13. A method of manufacturing the film carrier tape according to claim 9, which is characterized in that
a resin film layer is formed on the low profile glossy surface of the electro-deposited copper foil with its surface roughness (Rzjis) being not more than 1.5 μm and its brightness (Gs (60°)) being not less than 400 to form a flexible copper clad laminate as a tape, followed by etching the electro-deposited copper foil layer to form a film carrier tape with wiring.
